(19) United States
(12) Patent Application Publication
(10) Pub. No.: US 2014/0033901 A1
(43) Pub. Date: Feb. 6, 2014

(54) System for and Method of Operating a Web-Enabled Karaoke Device

(71) Applicant: Rashid MOIN, Centreville, VA (US)

(72) Inventor: Rashid MOIN, Centreville, VA (US)

(21) Appl. No.: 13/956,129

(22) Filed: Jul. 31, 2013

Related U.S. Application Data
(60) Provisional application No. 61/678,221, filed on Aug. 1, 2012.

(51) Int. Cl. G10H 1/36

(52) U.S. Cl. CPC G10H 1/36
USPC 84/610

(57) ABSTRACT

A web-enabled karaoke device includes software and hardware component which allow the web-enabled karaoke device to communicatively connect with a remote server. The user of the web-enabled karaoke device can access an online media library, a software application marketplace, and a cloud storage database of the remote server through a particular user account. Once control software authenticates the particular user account, the user can stream, download, create, and upload different media files through the particular user account by accessing the online media library, the software application marketplace, and the cloud storage database.

The current application claims a priority to the U.S. Provisional Patent application Ser. No. 61/678,221 filed on Aug. 1, 2012.

### FIELD OF THE INVENTION

The present invention relates to a household karaoke machine that is connected to the internet for many uses. More specifically, a karaoke machine with a small hardware that is integrated with software that provides means to access, create, and collaborate media contents on the internet software. The hardware connects to televisions set and has two inputs for microphones, electric guitar, and keyboard. The hardware is connected to a network with the ability to download and stream songs, as well as the ability to upload user created songs.

### BACKGROUND OF THE INVENTION

Karaoke machines are very popular in many restaurants and bars but are not as popular out of the home. This is because there has not been a proper interface for hardware that makes it easy to use in the home. Expanding on the idea of ease of use, nowadays people do not really use CD's to purchase or play songs but they download music to a hard drive. Also in this day and age of social networking there is not an interface that easily allows sharing the songs that the user may have created with the user's friends or the whole world. Considering these issues, to make an effective product for the home there needs to be hardware that is integrated with software and the internet to make a more enjoyable product.

Normal karaoke machines are becoming outdated and in this day and age so that changes have to be made in order to make the karaoke machines more appealing to the newer generation. To make karaoke more appealing, it needs to be easy to use and integrated with social networking. Even though there are karaoke machines that connect to the internet to store songs there is not one where you can easily purchase and sell songs on one interface that you can access from the one piece of hardware. There are even karaoke machines that allow you to download songs to play them but none have the idea of having a vast library by integrating with marketplaces that have already established themselves along with having a new database. Additionally there are no prior karaoke machines that allow the user to easily create a song with the hardware and then easily upload the songs that were created to online websites.

It is therefore the object of the present invention to provide a hardware and software combination that allows the user to easily buy and sell songs from the hardware. It also allows the user to easily share any songs, which are created by the user, with their friends through online websites and social media networks.

### BRIEF DESCRIPTION OF THE DRAWINGS

FIG. 1 is a perspective front view of the present invention.

FIG. 2 is a perspective back view of the present invention.

FIG. 3 is a view of the system for the present invention.

FIG. 4 is a perspective view of the present, wherein the present invention is in use and connected to Internet through a wired connection.

FIG. 5 is a perspective view of the present, wherein the present invention is in use and connected to Internet through a wireless connection.

FIG. 6 is a flow chart illustrating the overall operating process of the present invention.

FIG. 7 is a flow chart illustrating the overall operating process that allows the present invention to stream media files from the online media library.

FIG. 8 is a flow chart illustrating the overall operating process that allows the present invention to download and stream media files from the online media library.

FIG. 9 is a flow chart illustrating the overall operating process that allows the present invention to create media files through the recording platform.

FIG. 10 is a flow chart illustrating the uploading process of the final media compose file.

FIG. 11 is a flow chart illustrating the overall operating process that allows the present invention to download software applications from the software application marketplace.

FIG. 12 is a flow chart illustrating the overall operating process that allows the present invention to access the user media library.

### DETAIL DESCRIPTIONS OF THE INVENTION

All illustrations of the drawings are for the purpose of describing selected versions of the present invention and are not intended to limit the scope of the present invention.

The present invention is a web-enabled karaoke device 1 that comprises hardware and software combination installed within so that the present invention can stream, download, create, and upload media. The media includes, but is not limited to, songs, movies, games, and software application. The present invention communicatively links with at least one remote server through the internet in order to optimize the functionality within the present invention but can also function without communicatively linking with the at least one remote server, where the lack of internet connection limits some of the functionality within.

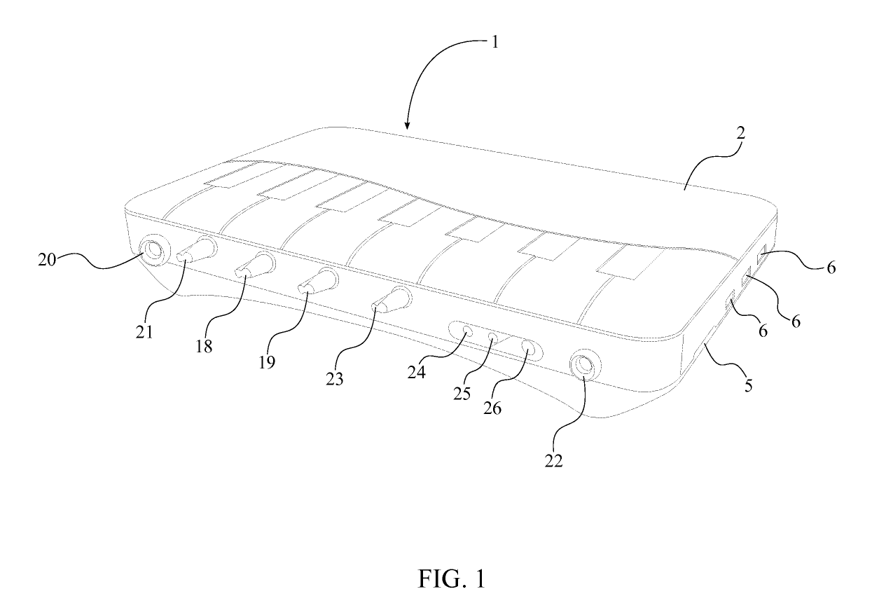

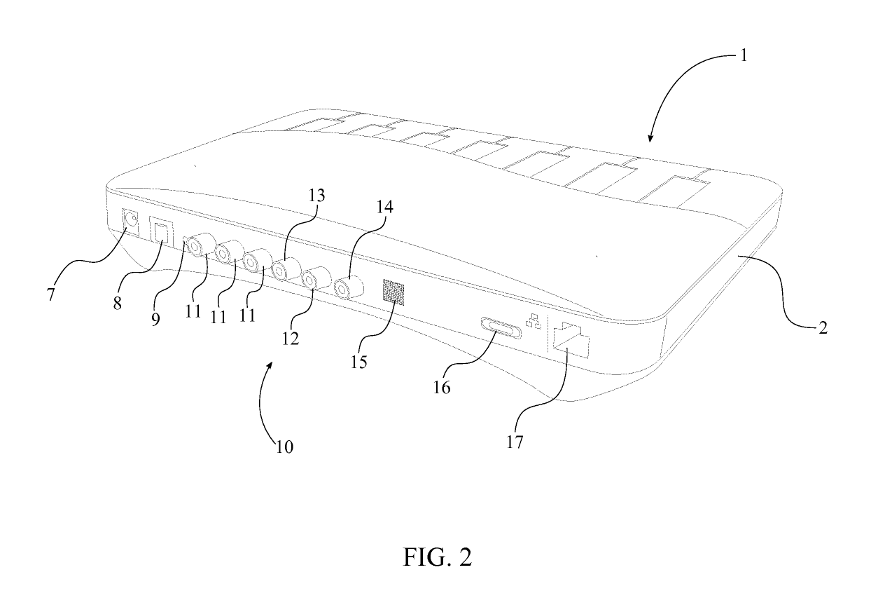

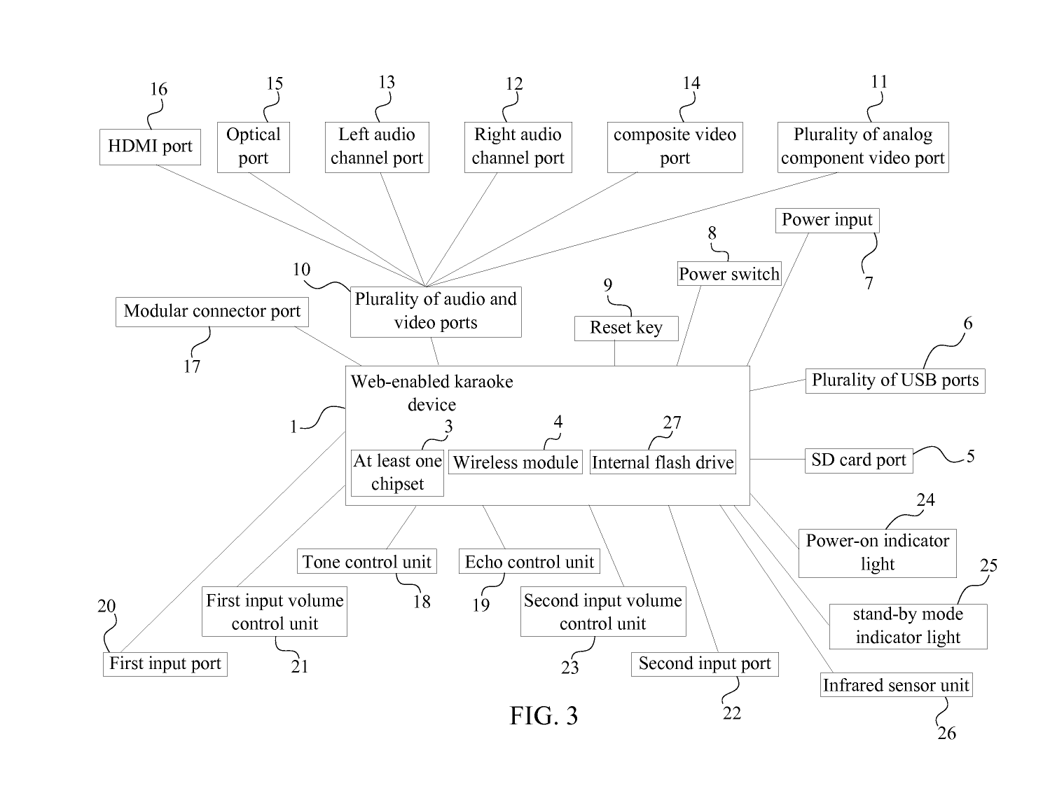

In reference to FIG. 1, FIG. 2, and FIG. 3, the web-enabled karaoke device 1 comprises a body 2, where the body 2 provides the platform for the rest of the components and their positioning. The body 2 is preferably made into rectangular shape so that the present invention can seamlessly blend in with other electronic devices such as, video game consoles, audio receivers, DVD players, and blu-ray players. At least one chipset 3, an internal flash drive 27, and a wireless module 4 of the present invention are positioned within the body 2. The at least one chipset 3, which includes the customized Android operating system, functions as the central processing system of the present invention executing all of the inputs commands and the outputs commands of the present invention. The internal flash drive 27 provides storage space for the present invention so that system settings, user settings, and variety of other operating system files that needs to be stored can be securely stored within the present invention. The internal flash drive 27 is electronically connected with the at least one chipset 3 within the body 2. The wireless module 4 communicatively couples the present invention with a wireless router 31 so that the present invention can wirelessly connect with the internet, and the wireless module 4 is electronically connected with the at least one chipset 3 within the body 2. A power input 7 and a power switch 8 of the present invention, which is electronically connected with the at least one chipset 3, are preferably traversed through the rear side of the body 2. The power input 7 provides an electrical outlet in order to attach an external power source so that the present invention can be electrically powered. The power switch 8 functions as the on/off switch within the present invention so that the electrical power from the power input 7 can be turned on or turned off by the user. When an external power source is attached with the present invention through the power input 7 and the power switch 8 is at the on-position, a power-on indicator light 24 of the present invention is illuminated. The power-on indicator light 24 provides visual confirmation to the user so that the user able to notice that the present invention is powered and turned-on. A stand-by mode indicator light 25 provides further visual confirmation to the user so that the user able to notice that the present invention is powered, turned-on, and running, where the present invention is not in a stand-by mode. The power-on indicator light 24 and the stand-by mode indicator light 25 are preferably traversed through the front side of the body 2 and electronically connect with the at least one chipset 3 within the body 2. The power-on indicator light 24 and the stand-by mode indicator light 25 illuminate with two different unique colors so that the user can distinguish the difference functionalities. For example, the power-on indicator light 24 illuminates with red color, and the stand-by mode indicator light 25 illuminates with green color. A reset key 9 of the present invention is traversed through the body 2 adjacent to the power switch 8 and electronically connected with the at least one chipset 3 within the body 2. The reset key 9 functions as the rest button so that the present invention can reboot or reset by the user when necessary. The reset key 9 is offset into the body 2 in order to avoid accidental reboot or reset.

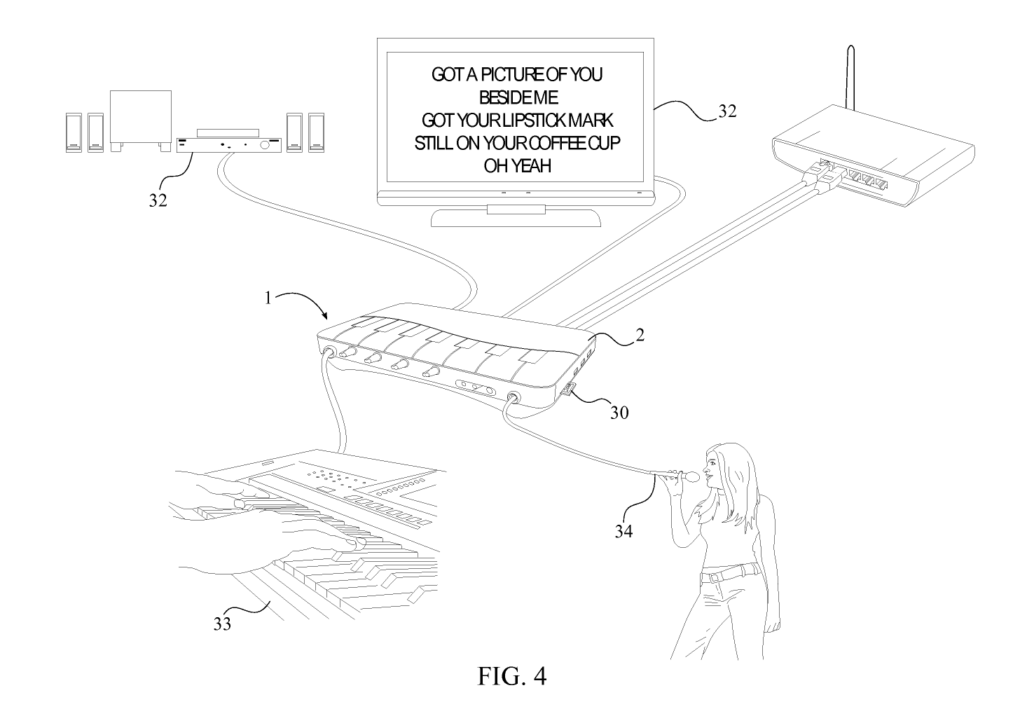

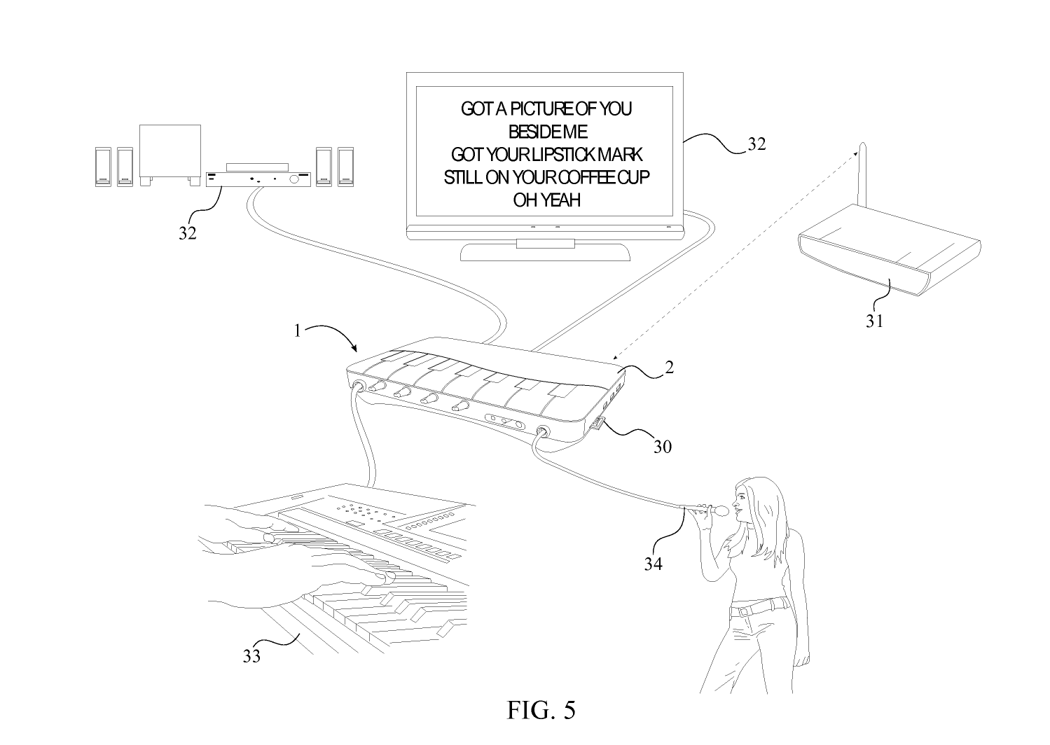

As shown in FIG. 4 and FIG. 5, a secure digital (SD) card port 5 and a plurality of universal serial bus (USB) ports 6 of the present invention are traversed through the body 2 and positioned on the side surface of the body 2. The SD card port 5 is electronically connected with the at least one chipset 3 within the body 2, where the SD card port 5 provides a connection port for an external secured digital (SD) card 30. Once the external SD card 30 is inserted by the user, the external SD card 30 electronically connects with the SD card port 5 where the external SD card 30 functions as an external storage device. The plurality of USB ports 6 is electronically connected with the at least one chipset 3 within the body 2, where the plurality of USB ports 6 provides connection ports for externally attached devices such as portable storage devices, wireless receiver units, and video cameras. The plurality of USB ports 6 includes, but is not limited to, mini ports, micro ports, standard ports, and any other sort of USB ports.

In reference to FIG.4 and FIG. 5, a plurality of audio and video ports 10 and a modular connector port 17 of the present invention are traversed through the body 2 and electronically connect with the at least one chipset 3 within the body 2. The plurality of audio and video ports 10 and the modular connector port 17 electronically connect the present invention with a plurality of output devices 32, where the plurality of output devices 32 includes, but is not limited to, a display screen, a television, a computer, a home theater sound system, router, and a combination of thereof. At least one device from the plurality of output devices 32 is required for the present invention to function properly as long as audio features and video features can be outputted through the at least one device of the plurality of output devices 32. In order to compensate for different connection points of the plurality of output devices 32, the plurality of audio and video ports 10 includes, but not limited to, a plurality of analog component video ports 11, a right audio channel port 12, a left audio channel port 13, a composite video port 14, an optical port 15, a high-definition multimedia interface (HDMI) port 16, and a combination of thereof. Even though the present invention connects with the internet through the wireless module 4 and the wireless router 31, the modular connector port 17 provides an additional connection port so that the present invention can connect with a router through a connection cable in order to access internet. The user of the present invention has the option to choose either the modular connector port 17 or the wireless module 4 to connect with the internet upon the user's preference and the availability of wireless network, where the wireless module 4 provides a wireless connection and the modular connector port 17 provides a wired connection.

A tone control unit 18, an echo control unit 19, a first input port 20, a first input volume control unit 21, a second input port 22, and a second input volume control unit 23 of the present invention are traversed into the body 2 and positioned on the front side of the body 2. The tone control unit 18, the echo control unit 19, the first input port 20, the first input volume control unit 21, the second input port 22, and the second input volume control unit 23 are electronically connected with the at least one chipset 3 within the body 2. As shown in FIG. 5, the first input port 20 of the present invention allows the user to plug in a musical instrument 33, such as a keyboard, an electric guitar, an electronic percussion device, and other similar instrument, in such way that the musical instrument 33 is communicatively coupled with the first input port 20. The first input port 20 transfers audio files from the musical instrument 33 into the present invention, where the audio volume of the audio files is controlled by the first input volume control unit 21. The first input volume control unit 21 is preferably positioned adjacent with the first input port 20. The second input port 22 of the present invention allows the user to plug in a microphone 34 in such way that the microphone 34 is communicatively coupled with the second input port 22. The second input port 22 transfers audio files from the microphone 34 into the present invention, where the audio volume of the audio files is controlled by the second input volume control unit 23. The second input volume control unit 23 is preferably positioned adjacent with the second input port 22. The musical instrument 33 of the first input port 20 and the microphone 34 of the second input port 22 are preferably attached through quarter inch XLR cables within the present invention. In an alternative configuration, the musical instrument 33 of the first input port 20 and the microphone 34 of the second input port 22 can be wirelessly connected through separate wireless receivers which are plugged into the first input port 20 and the second input port 22. The echo control unit 19 and the tone control unit 18 provide adjustment knobs so that the user can adjust the sound quality of the transferred audio files according to the user's preference. There are various additional musical effects that can be applied to the sound quality of the transferred audio files through the use of a remote control which is explained below. The various additional musical effects can be only controlled trough the remote control as they do not have any respective physically adjustment knobs on the body 2.

An infrared sensor unit 26 of the present invention is traversed through the body 2, where the infrared sensor unit 26 is positioned on the front side of the body 2. The infrared sensor unit 26 is electronically connected with the at least one chip set 3 within the body 2. The infrared sensor unit 26 allows the user of the present invention to remotely access the present invention from the remote control. The remote control is remotely coupled with the infrared sensor unit 26; where the remote control is able fully control all of the functionalities of the present invention.

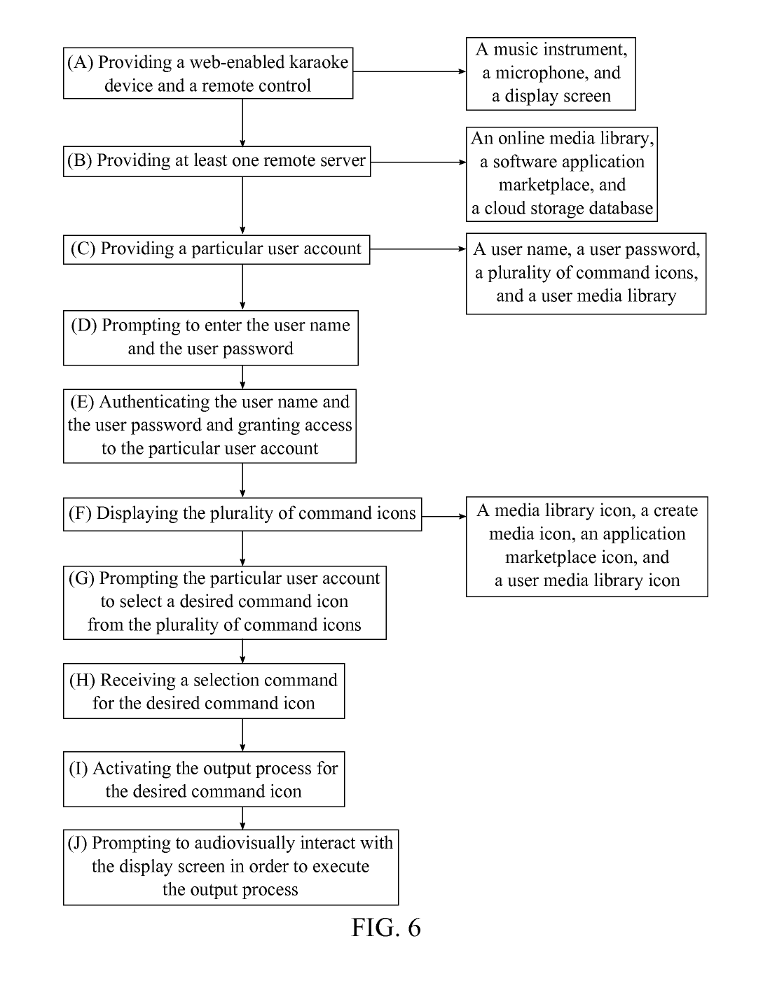

In reference to FIG. 6, control software of the present invention allows the user to control the present invention once the internet connection between the present invention and the at least one remote server is established through the wireless module 4 or the modular connector port 17. The at least one remote server that the present invention is connected with comprises an online media library, a software application marketplace, and a cloud storage database. The at least one remote server can be accessed by a particular user account, where the particular user account is linked with the present invention and comprises a user name, a user password, a plurality of command icons, and a user media library. Controlling process of the present invention begins when the control software prompts the user to enter the user name and user password in order to access the particular user account. The user of the particular user account then enters the user name and the user password through the remote control, where the user is able to view the entered information through the display screen. The control software then authenticates the user name and the user password and grants access to the particular user account. Once the user is granted access to the particular user account, the control software displays the plurality of command icons to the user through the display screen. The plurality of command icons of the present invention includes a media library icon, a create media icon, an application marketplace icon, and a user media library icon. Then the control software prompts the user to select a desired command icon from the plurality of command icons. The user of the particular user account then selects the desired command icon upon user's preference through the remote control. Once the user selects the desired command icon, a selection command for the desired command icon is received from the remote control. Then the control software activates an output process for the desired command icon, where each of the plurality of command icons is linked with a respective output process. The control software then prompts the particular user account to audiovisually interact with the display screen in order to execute the output process for the desired command icon. Since the output process for each of the plurality of command icon is different from one another, the output process and the audiovisually interaction of the present invention completely depend on the selection of the desired command icon.

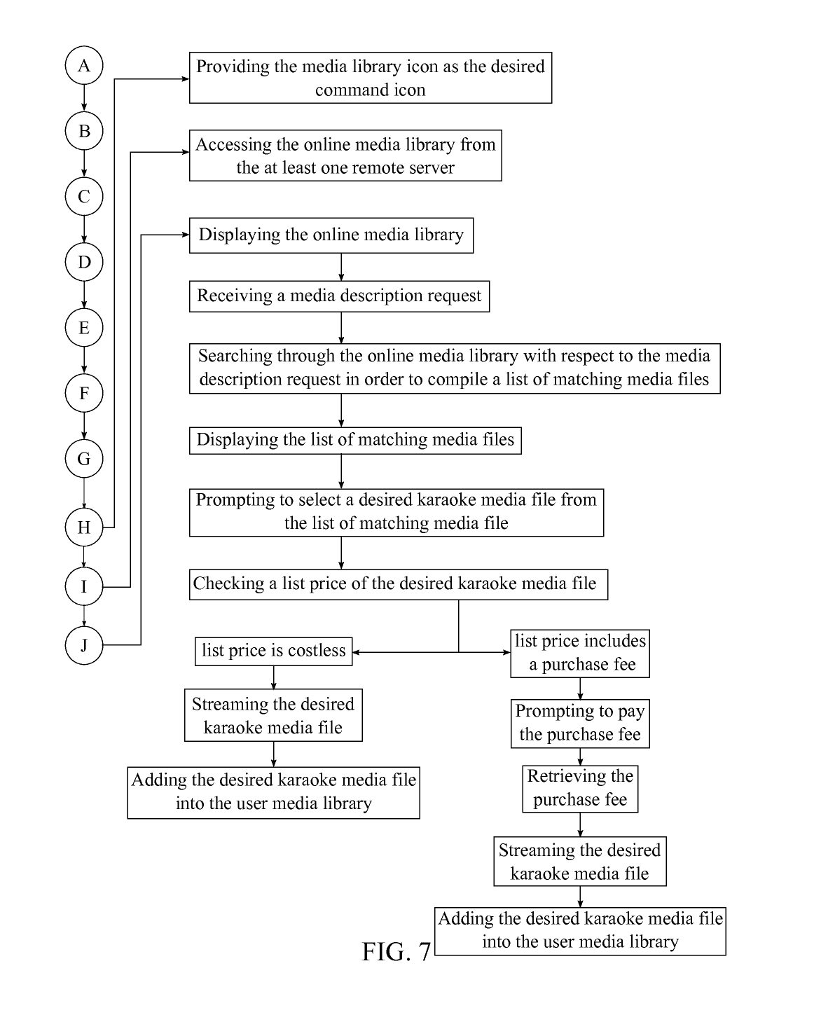

In reference to FIG. 7, when the user of the particular user account selects the media library icon as the desired command icon, the control software accesses the online media library from the at least one remote server. Then the online media library is displayed to the particular user account through the display screen. Once the online media library is displayed to the user, the user can choose a media file from the online media library. The online media library is completed with a plurality of host media files and also partnered with a wide variety outsourced servers that includes a plurality of outsourced media files so that the user has the option to choose from a vast catalog of media files. In order to narrow down the selection of the media file within the online media library, the user of the particular user account can enter a media description request. After the media description request is received by the control software, the control software searches through the plurality of host media files of the online media library in order to compile a list of matching media files with respect to the media description request. If the control software can't compile the list of matching media files from the plurality of host media files of the online media library, the control software downloads the respective matching media files from the plurality of outsourced media files of the outsourced servers in order to compile the list of matching media files. Even though the control software uses the outsourced servers, the user of the present invention is not required to do any extra step as the control software completes the flawless transaction in between the at least one remote server and the outsourced servers. The control software then displays the list of matching media files to the user of the particular user account through the display screen and prompts the particular user account to select a desired karaoke media file from the list of matching media files. Once the user of the particular user account selects the desired karaoke media file, the control software checks the list price of the desired karaoke media file on the cloud storage database. For example, the user can enter a song title as the media description request, and then the control software compiles all of the media files that contain the same song title into the list of matching song titles. The control software then display the list of matching song title to the user through the display screen and prompts the particular user account to select the desired song, where the user is able to select the desired song through the remote control.

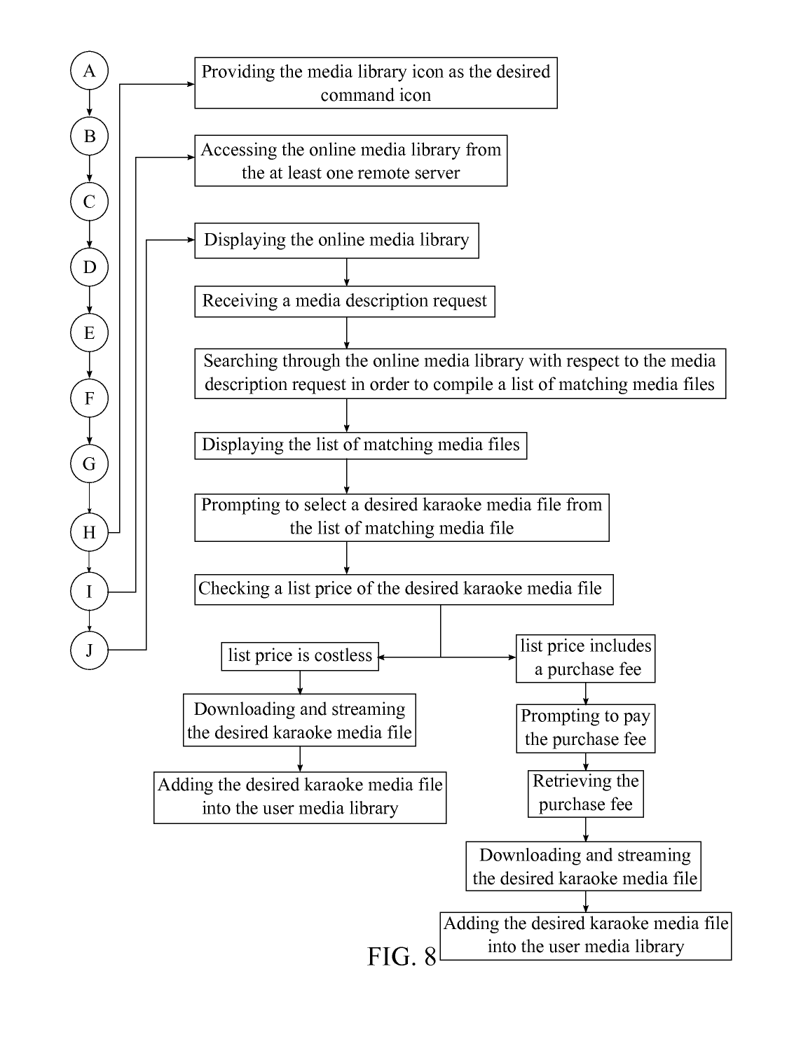

In reference to FIG. 7 and FIG. 8, if the control software recognizes that the list price of the desired karaoke media file is costless, the control software identifies that the desired karaoke media file is stored within a public cloud of the cloud storage database. The public cloud is freely opened for everyone and does not charge a payment to either stream or download the desired karaoke file. Once the control software identifies the desired karaoke media file, the user has the option to either stream or download the desired karaoke file. If the user of the particular user account decides only to stream the desired karaoke media file, the control software streams the video features and the audio features of the desired karaoke media file through the display screen. If the user of the particular user account decides to download the desired karaoke media file, the control software downloads the desired karaoke media file into the present invention while simultaneously streams the video features and the audio features of the desired karaoke media file through the display screen. After the desired media file is downloaded, the desired media file is stored within the internal flash drive 27 of the present invention, where the control software restricts the coping of the desired media file from the internal flash drive 27 to an external storage device. Once the desired karaoke media file is either downloaded or streamed within the present invention, the desired karaoke media file is added into the user media library as a shortcut so that the particular user account can access the streamed desired media files and the downloaded desired media files through the user media library.

In reference to FIG. 7 and FIG. 8, if the control software recognizes that the list price of the desired karaoke media file includes a purchase fee, the control software identifies that the desired karaoke media file is stored within a private cloud of the cloud storage database. Unlike the public cloud, the private cloud charges a payment to either stream or download the desired karaoke file. Once the desired karaoke media file is identified within the private cloud by the control software, the control software prompts the particular user account to pay the purchase fee for the desired karaoke media file. The user of the particular user account can use any kind of online payment method to pay the purchase fee for the desired karaoke media. To enhance usability of the present invention, the user of the particular user account can set up a payment account with secure form of payment methods so that the user can easily pay the purchase fee with a one click option to buy the desired karaoke media file. Once the control software retrieves the purchase fee, the control software enables the desired karaoke media file to be stream or download, where the user has the option to either stream or download the desired karaoke file. If the user of the particular user account decides only to stream the desired karaoke media file, the control software streams the video features and the audio features of the desired karaoke media file through the display screen. If the user of the particular user account decides to download the desired karaoke media file, the control software downloads the desired karaoke media file into the present invention while simultaneously streams the video features and the audio features of the desired karaoke media file through the display screen. After the desired media file is downloaded, the desired media file is stored within the internal flash drive 27 of the present invention, where the control software restricts the coping of the desired media file from the internal flash drive 27 to an external storage device. Once the desired karaoke media file is either downloaded or streamed within the present invention, the desired karaoke media file is added into the user media library as a shortcut so that the particular user can access the streamed desired media files and the downloaded desired media files through the user media library.

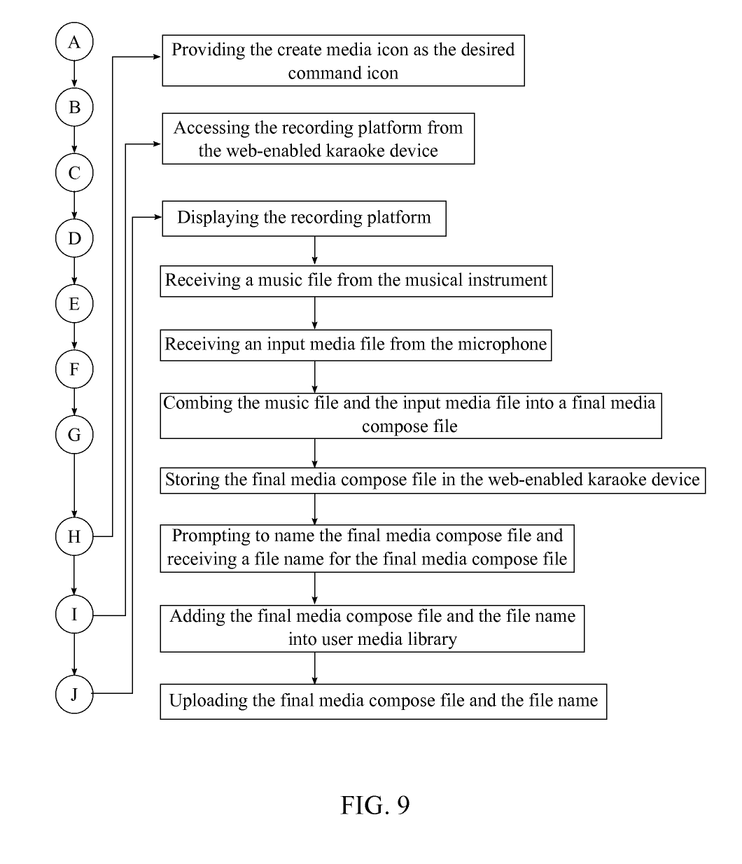

In reference to FIG. 9, when the user of the particular user account selects the create media icon as the desired command icon, the control software accesses a recording platform of the present invention. Then the recording platform is displayed to the particular user account through the display screen. Once the recording platform is displayed to the user, the user is able to create a media compose file through the communicatively coupled musical instrument 33 and the communicatively coupled microphone 34. In order to create the media compose file, the user has to provide input data though the communicatively coupled musical instrument 33 and the microphone 34. The tone control unit 18 and the echo control unit 19 provide mixing capability within the present invention so that user is able to fully control the input data from the communicatively coupled musical instrument 33 and the microphone 34. There are various additional musical effects that can only be mixed through the use of the remote control, wherein those musical effects don't have any respective physical control units on the body 2. The present invention respectively receives a music file and an input media file from the communicatively coupled musical instrument 33 and the communicatively coupled microphone 34, where the input media file of the present invention is either a vocal file or an additional music file. The control software then combines the music file and the input media file into a final media compose file, and stores the final media compose file within the present invention with a file name. If a webcam is connected to the present invention through one of the plurality of USB ports 6, a video file from the webcam is also combined into the final media compose file. The user can also combine existing open licensed media files, such as downloaded media files from the Internet or locally stored media files within the internal flash drive 27 or the external SD card 30, along with the music file and the input media file in order to create the final media compose file. The file name is prompted by the control software during the storing process so that the final media compose file can be easily identified. Since the final media compose file is created by the user of the particular user account, the user can store the final media compose file in the internal flash drive 27 or any of the external storage devices and has full control over the final media compose file. Then the control software adds the final media compose file and the file name into the user media library. The control software can also help the user to rate and train their vocals or music. Further, it can help the user to develop a karaoke version of their final media compose file. Once the final media compose file is added into the user media library, the control software enables the user of the particular user account to upload the final media compose file into a virtual location away from the present invention.

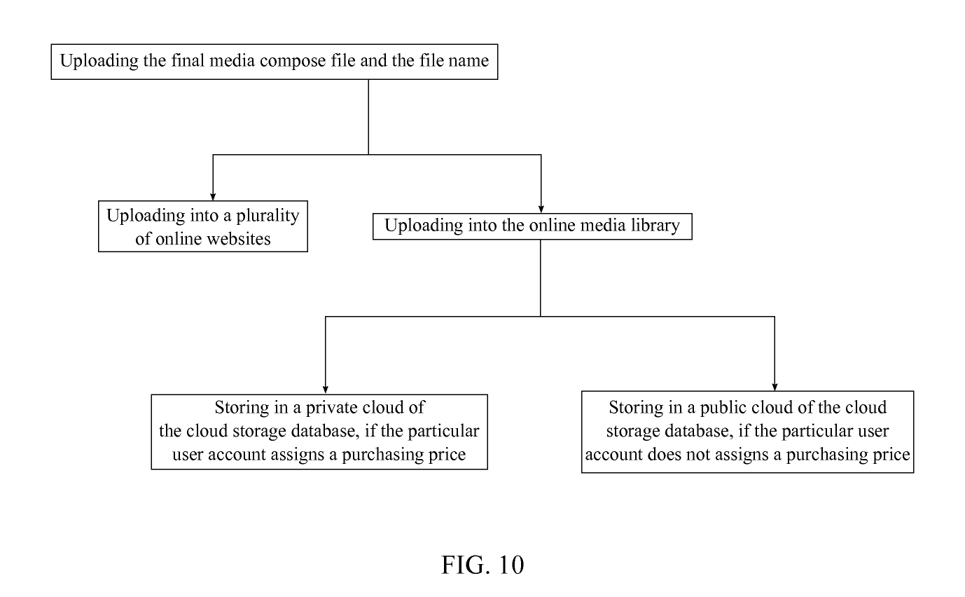

In reference to FIG. 10, the user of the particular user account can upload the final media compose file and the file name into a plurality of online websites, includes, but is not limited to, a plurality of social media websites, a plurality of talent competition or training website, and a plurality of media websites. For example, if the user wants to enter a television based singing competition or singing training, the user is able to upload the final media compose file into the appropriate websites during the sign up process as the entrance audio file. The user of the particular user account can also upload the final media compose file into the online media library of the at least one remote server. Once the final media compose file is uploaded into the online media library, the user can store the final media compose file with two different methods. As for the first method, the user can store the final media compose file within the private cloud of the cloud storage database, where the user assigns a purchasing price for the final media compose file. When the final media compose file is stored within the private cloud, the final media compose file is not freely available for everyone and can be access only after paying the purchase fee. As for the second method, the user can store the final media compose file within the public cloud of the cloud storage database, where the user does not assign the purchasing price for the final media compose file. When the final media compose file is stored within the public cloud, the final media compose file is freely available for everyone and can be accessed without having to pay the purchase fee.

Similar to the particular user account, other user accounts of the at least one remote server is also able to upload the final media compose files into the online media library. Once the final media compose files are uploaded into the online media library with the file names, the final media compose files become part of the online media library, where the final media compose files are either freely available or available with the purchase fee to all of the user accounts of the at least one remote server.

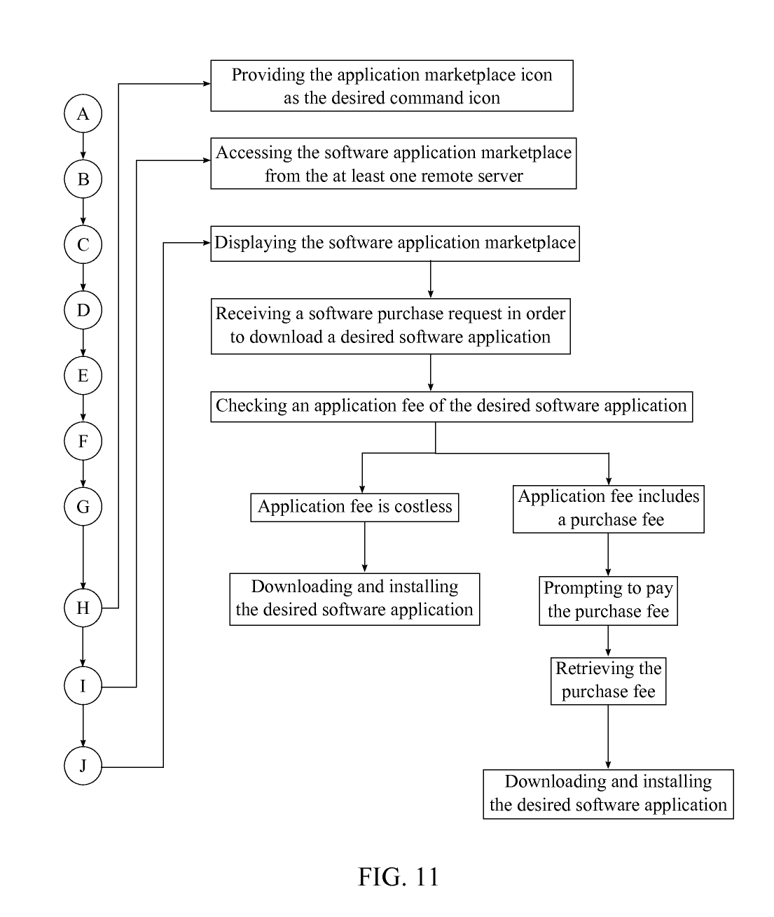

In reference to FIG. 11, when the user of the particular user account selects the application marketplace icon as the desired command icon, the control software accesses the software application marketplace from the at least one remote server. Then the software application marketplace is displayed to the particular user account through the display screen, where the user is able select the any software application from the software application marketplace. The software application marketplace includes, but is not limited to, movie applications, TV-show applications, music applications, social networking applications, game applications, sport applications, medical applications, finance applications, entertainment applications, educational applications, and productivity applications. Once the user selects a desired software application, the control software receives a software purchase request from the particular user account in order to download the desired software application from the software application marketplace. Then the control software checks for an application fee of the desired software application on the cloud storage database. If the control software recognizes that the application fee of the desired software application is costless, the control software identifies that the desired software application is stored within a public cloud of the cloud storage database. Then the control software downloads and installs the desired software application to the present invention. If the control software recognizes that the application fee of the desired software application includes the purchase fee, the control software identifies that the desired software application is stored within the private cloud of the cloud storage database. Once the desired software application is identified within the private cloud, the control software prompts the particular user account to pay the purchase fee for the desired software application. Then the user can use any kind of online payment method or the payment account to pay the purchase fee for the desired software application. Once the control software retrieves the purchase fee, the control software downloads and installs the desired software application to the present invention.

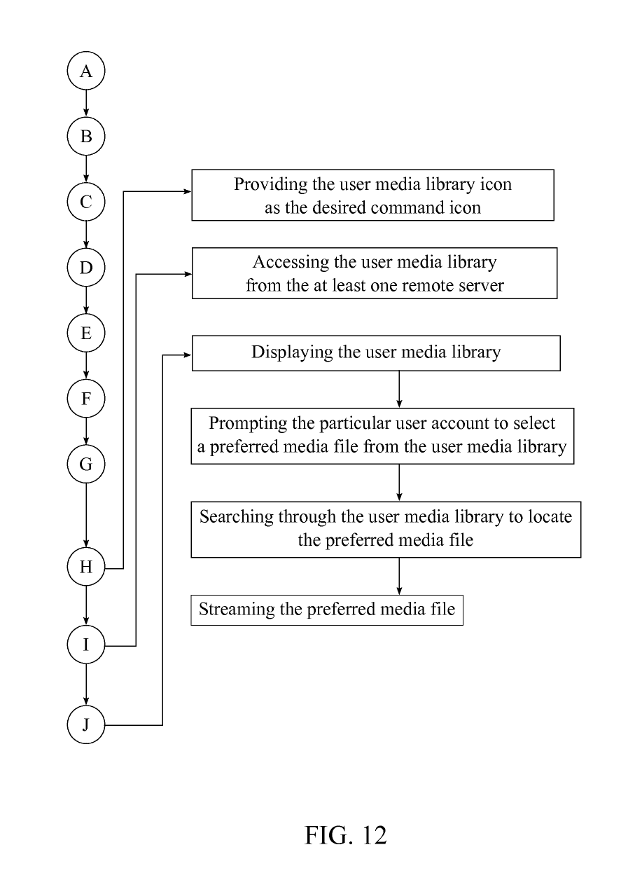

In reference to FIG. 12, when the user of the particular user account selects the user media library icon as the desired command icon, the control software accesses the user media library from the at least one remote server. Then the user media library is displayed to the particular user account through the display screen, where the user is able select from the streamed and downloaded desired media files and the final media compose files from the user media library. Then the control software prompts the user of the particular user account to select a preferred media file from the user media library. Once the user selects a preferred media file from the user media library, the control software searches through the user media library to locate the preferred media file. Then the control software streams the preferred media file thought the display screen.

The cloud storage database of the present invention provides storage space for all of the user accounts, but there is also the option of using the cloud service of the reputable partners if extra storage space is needed. If the extra storage space is needed within the present invention, the control software directly routes the media that need to be saved by the users to the cloud service of the reputable partners, where the user is not required to take any extra actions or steps if the media files need to be saved to the cloud service of the reputable partners.

Although the invention has been explained in relation to its preferred embodiment, it is to be understood that many other possible modifications and variations can be made without departing from the spirit and scope of the invention as hereinafter claimed.

1. A web-enabled karaoke device comprises:
a body;
a at least one chipset;
a wireless module;
an internal flash drive;
a secure digital (SD) card port;
a plurality of universal serial bus (USB) ports;
a power input;
a power switch;
a reset key;
a plurality of audio and video ports;
a modular connector port;
a tone control unit;
an echo control unit;
a first input port;
a first input volume control unit;
a second input port;
a second input volume control unit;
a power-on indicator light;
a stand-by mode indicator light;
an infrared sensor unit;
the at least one chipset, the internal flash drive, and the wireless module being positioned within the body; and
the SD card port, the plurality of USB ports, the power input, the power switch, the reset key, the plurality of audio and video ports, the modular connector port, the tone control unit, the echo control unit, the first input port, the first input volume control unit, the second input port, the second input volume control unit, the power-on indicator light, the stand-by mode indicator light, and the infrared sensor unit traversing through the body.

2. The web-enabled karaoke device as claimed in claim 1 comprises:
the SD card port, the plurality of USB ports, the power input, the power switch, the reset key, the plurality of audio and video ports, the modular connector port, the tone control unit, the echo control unit, the first input port, the first input volume control unit, the second input port, the second input volume control unit, the power-on indicator light, the stand-by mode indicator light, the infrared sensor unit, the internal flash drive, and the wireless module being electronically connected with the at least one chipset.

3. The web-enabled karaoke device as claimed in claim 2 comprises:
the plurality of audio and video ports comprises ports selected from the group consisting of a plurality of analog component video ports, a right audio channel port, a left audio channel port, a composite video port, an optical port, a high-definition multimedia interface (HDMI) port, and a combination of thereof.

4. The web-enabled karaoke device as claimed in claim 1 comprises:
the SD card port being electronically connected with an external secured digital (SD) card, wherein the SD is inserted by a user for data storage; and
the wireless module being communicatively coupled with a wireless router, wherein the wireless router connects with the Internet.

5. The web-enabled karaoke device as claimed in claim 1 comprises:
the plurality of audio and video ports being electronically connected with a plurality of output devices;
the plurality of output devices comprises devices selected from the group consisting of a television, a computer, a home theater system, and a combination thereof;
the first input port being communicatively coupled with a musical instrument;
the musical instrument comprises instrument selected from the group consisting of a keyboard, an electronic guitar, and an electronic percussion device;
the second input port being communicatively coupled with a microphone; and
the infrared sensor unit being remotely coupled with a remote control.

6. A method of operating a web-enabled karaoke device by executing computer-executable instructions stored on a non-transitory computer-readable medium, the method comprises the steps of:
(A) providing a web-enabled karaoke device and a remote control, wherein the web-enabled karaoke device comprises a recording platform, a first input port with an electronically coupled musical instrument, a second input port with an electronically coupled microphone, and a plurality of audio and video ports with an electronically coupled display screen for video features and audio features;
(B) providing at least one remote server, wherein the at least one remote server comprises an online media library, a software application marketplace, and a cloud storage database;
(C) providing a particular user account, wherein the particular user account comprises a user name, a user password, a plurality of command icons, and a user media library;
(D) prompting to enter the user name and the user password through the display screen and the remote control in order to access the particular user account;
(E) authenticating the user name and the user password and granting access to the particular user account;
(F) displaying the plurality of command icons through the display screen, wherein the plurality of command icons includes a media library icon, a create media icon, an application marketplace icon, and a user media library icon;
(G) prompting the particular user account to select a desired command icon from the plurality of command icons through the display screen;
(H) receiving a selection command for the desired command icon from the remote control, wherein each of the plurality of command icons is linked to an output process;
(I) activating the output process for the desired command icon; and
(J) prompting to audiovisually interact with the display screen in order to execute the output process for the desired command icon.

7. The method of operating a web-enabled karaoke device by executing computer-executable instructions stored on a non-transitory computer-readable medium, the method as claimed in claim 6 comprises the steps of:
providing the media library icon as the desired command icon;
accessing the online media library from the at least one remote server;
displaying the online media library to the particular user account through the display screen;
receiving a media description request from the particular user account, wherein the media description request narrow downs the online media library;
searching through the online media library with respect to the media description request in order to compile a list of matching media files;
displaying the list of matching media files through the display screen;
prompting the particular user account to select a desired karaoke media file from the list of matching media files; and
checking a list price of the desired karaoke media file on the cloud storage database.

8. The method of operating a web-enabled karaoke device by executing computer-executable instructions stored on a non-transitory computer-readable medium, the method as claimed in claim 7 comprises the steps of:
providing the list price of the desired karaoke media file is costless;
identifying the desired karaoke media file is stored within a public cloud of the cloud storage database, wherein the public cloud does not charge a payment for the desired karaoke media file;
streaming the video features and the audio features of the desired karaoke media file through the display screen,
if the particular user account chooses to stream the desired karaoke media file; and
adding the desired karaoke media file into the user media library.

9. The method of operating a web-enabled karaoke device by executing computer-executable instructions stored on a non-transitory computer-readable medium, the method as claimed in claim 7 comprises the steps of:
providing the list price of the desired karaoke media file includes a purchase fee;
identifying the desired karaoke media file is stored within a private cloud of the cloud storage database, wherein the private cloud charges the purchase fee for the desired karaoke media file;
prompting the particular user account to pay the purchase fee for the desired karaoke media file;
retrieving the purchase fee for the desired karaoke media file;
streaming the video features and the audio features of the desired karaoke media file through the display screen,
if the particular user account chooses to stream the desired karaoke media file; and
adding the desired karaoke media file into the user media library.

10. The method of operating a web-enabled karaoke device by executing computer-executable instructions stored on a non-transitory computer-readable medium, the method as claimed in claim 7 comprises the steps of:
providing the list price of the desired karaoke media file is costless;
identifying the desired karaoke media file is stored within a public cloud of the cloud storage database, wherein the public cloud does not charge a payment for the desired karaoke media file;
downloading the desired karaoke media file into the web-enabled karaoke device,
if the particular user account chooses to download the desired karaoke media file;
simultaneously streaming the video features and the audio features of the desired karaoke media file through the display screen; and
adding the desired karaoke media file into the user media library.

11. The method of operating a web-enabled karaoke device by executing computer-executable instructions stored on a non-transitory computer-readable medium, the method as claimed in claim 7 comprises the steps of:
providing the list price of the desired karaoke media file includes a purchase fee;
identifying the desired karaoke media file is stored within a private cloud of the cloud storage database, wherein the private cloud charges a purchase fee for the desired karaoke media file;
prompting the particular user account to pay the purchase fee for the desired karaoke media file;
retrieving the purchase fee for the desired karaoke media file;
downloading the desired karaoke media file into the web-enabled karaoke device,
if the particular user account chooses to download the desired karaoke media file;
simultaneously streaming the video features and the audio features of the desired karaoke media file through the display screen; and
adding the desired karaoke media file into the user media library.

12. The method of operating a web-enabled karaoke device by executing computer-executable instructions stored on a non-transitory computer-readable medium, the method as claimed in claim 6 comprises the steps of:
providing the create media icon as the desired command icon;
accessing the recording platform from the web-enabled karaoke device;
displaying the recording platform to the particular user account through the display screen;
receiving a music file from the communicatively coupled musical instrument;
simultaneously receiving an input media file from the communicatively coupled microphone, wherein the input media file is either a vocal file or an additional music file;
combining the music file and the input media file into a final media compose file, wherein the final media compose file can also comprise a video file;
storing the final media compose file into the web-enabled karaoke device;
prompting to name the final media compose file and receiving a file name for the final media compose file;
adding the final media compose file and the file name into the user media library; and
uploading the final media compose file and the file name to a virtual location away from the web-enabled karaoke device.

13. The method of operating a web-enabled karaoke device by executing computer-executable instructions stored on a non-transitory computer-readable medium, the method as claimed in claim 12 comprises the steps of:
uploading the final media file and the file name into a plurality of online websites, wherein the plurality of online websites comprises a plurality of social media websites, a plurality of talent competition or training websites, and a plurality of media websites.

14. The method of operating a web-enabled karaoke device by executing computer-executable instructions stored on a non-transitory computer-readable medium, the method as claimed in claim 12 comprises the steps of:
uploading the final media file and the file name into the online media library of the at least one remote server.

15. The method of operating a web-enabled karaoke device by executing computer-executable instructions stored on a non-transitory computer-readable medium, the method as claimed in claim 14 comprises the steps of:
storing in the final media file and the file name within a private cloud of the cloud storage database,
if the particular user account assigns a purchasing price for the final media file.

16. The method of operating a web-enabled karaoke device by executing computer-executable instructions stored on a non-transitory computer-readable medium, the method as claimed in claim 14 comprises the steps of:
storing in the final media file and the file name within a public cloud of the cloud storage database,
if the particular user account does not assign a purchasing price for the final media file.

17. The method of operating a web-enabled karaoke device by executing computer-executable instructions stored on a non-transitory computer-readable medium, the method as claimed in claim 6 comprises the steps of:
Providing the application marketplace icon as the desired command icon;
accessing the software application marketplace from the at least one remote server;
displaying the software application marketplace to the particular user account through the display screen;
receiving a software purchase request from the particular user account in order to download a desired software application from the software application marketplace; and
checking an application fee of the desired software application on the cloud storage database.

18. The method of operating a web-enabled karaoke device by executing computer-executable instructions stored on a non-transitory computer-readable medium, the method as claimed in claim 17 comprises the steps of:
providing the application fee of the desired software application is costless;
identifying the desired software application is stored within a public cloud of the cloud storage database, wherein the public cloud does not charge the application fee for the desired software application; and
downloading and installing the desired software application to the web-enabled karaoke device.

19. The method of operating a web-enabled karaoke device by executing computer-executable instructions stored on a non-transitory computer-readable medium, the method as claimed in claim 17 comprises the steps of:
providing the application fee of the desired software application includes a purchase fee;
identifying the desired software application is stored within a private cloud of the cloud storage database, wherein the private cloud charges the purchase fee for the desired software application;
prompting the particular user account to pay the purchase fee for the desired software application;
retrieving the purchase fee for the desired software application; and
downloading and installing the desired software application to the web-enabled karaoke device.

20. The method of operating a web-enabled karaoke device by executing computer-executable instructions stored on a non-transitory computer-readable medium, the method as claimed in claim 6 comprises the steps of:
providing the user media library icon as the desired command icon;
accessing the user media library from the at least one remote server;
displaying the user media library to the particular user account through the display screen;
prompting the particular user account to select a preferred media file from the user media library;
searching through the user media library to locate the preferred media file; and
streaming the preferred media file through the display screen.
